(19) United States
(12) Patent Application Publication
(10) Pub. No.: US 2003/0011239 A1
(43) Pub. Date: Jan. 16, 2003

(54) Hub with rectangular interior space

(76) Inventor: Shu-Chen Juan, Taipei (TW)

Correspondence Address: Shu-Chen Juan, 235 Chung-Ho, Box 8-24, Taipei, TW

(21) Appl. No.: 10/059,976

(22) Filed: Jan. 30, 2002

(30) Foreign Application Priority Data
Jul. 10, 2001 (TW) 090211702

(51) Int. Cl. B60B 27/00

(52) U.S. Cl. 301/110.5

(57) ABSTRACT

A hub with a rectangular interior space includes an outer sleeve in combination with in inner sleeve, rollers, a spindle and a bearing. In particular, a section of neck portion extending from a front end of outer sleeve can form a rectangular space with a disk surface projecting from a front end of inner sleeve for arrangement of multiple steel rollers therein. The outer edge of inner sleeve proximate to the tail end is coupled with a connecting seat by threaded engagement or tight fit or gluing or other means such that the inner side of the connecting seat can form another rectangular space with a corresponding position of outer sleeve for arrangement of multiple steel rollers therein. A bearing is disposed between the tail end of outer sleeve and spindle. A right side cover is finally positioned at a rear end of bearing so that outer sleeve and inner sleeve and spindle form three contact fulcrums to thereby increase the distance theramong during rotation, thereby facilitating manufacture and assembly of the structural elements and enabling smooth and stable rotation and strength of the structure.

### FIELD OF INVENTION

The present invention provides a hub with a rectangular interior space having an entire internal rectangular hub. The hub is formed by simple elements, but still maintains smooth rotation and has increased strength without deformation.

### DESCRIPTION OF PRIOR ART

A conventionally used hub with a rectangular interior space, referring to FIG. 1, includes outer sleeve 2 in combination with inner sleeve 3, rollers 4, 5, a notched roller bowl 6, a spindle 7, a large roller 8 and a roller press 9. The front end of outer sleeve 2 extends to form a section of neck portion, and the inner edge of the neck portion is formed as a curved groove 21, and front end of inner sleeve 3 that projects from the disk surface is formed as a curved groove 31, thereby forming a circular gap 32 for annular arrangement of roller 4 in the circular gap 32. The outer edge of inner sleeve 3 near the tail end threadedly engages notched roller bowl 6. The front end of the notched roller bowl 6 on outer periphery of outer sleeve 2, and the rear end thereof on the inner periphery of spindle 7 are respectively provided with curved grooves 61, 62, which combine with the curved groove 22 provided in the outer sleeve 2 opposite to the curved groove 6l. The curved groove 61 is provided in the outer periphery at the front end of notched roller bowl 6 so as to form a circular gap 23 for annular arrangement of roller 5 in the circular gap 23. The curved groove 62 at the end of notched roller bowl 23 also forms a circular gap 63 relative to roller press 9 for annular arrangement of large roller 8 in circular gap 63. Thereby, a complete internal rectangular type hub structure is formed, such that in the entire structure, outer sleeve 2 can rotate with inner sleeve 3 via rollers 4, 5. Inner sleeve 3 further rotates with the spindle 7 via the large roller 8, thereby providing smooth rotation of outer sleeve 2.

However, the aforesaid structure has the following drawbacks:

1. During initial manufacture process of the outer sleeve 2, the inner edge of the neck portion extending from the front end has to be formed with curved groove 21, and the projecting disk surface at the front end of inner sleeve 3 has to be correspondingly formed with curved groove 31 in order to constitute a circular gap 32 for annular arrangement of roller 4 in circular gap 32. As for notched roller bowl 6 engaging the rear end of inner sleeve 3, the front end at the outer periphery of outer sleeve 2, and the rear end at the inner periphery of spindle 7 thereof have to be respectively formed with curved grooves 61, 62. Besides, outer sleeve 2 has to be formed with a curved groove 22 therein opposite to curved groove 61 in outer periphery of the front end of notched roller bowl 6 so as to form circular gap 23 for annular arrangement of roller 5 in circular gap 23. Therefore, in order that outer sleeve 2 can rotate with inner sleeve 3 via rollers 4, 5, and in order that inner sleeve 3 can smoothly rotate with spindle 7 via the large roller 8, the curved groove 21 formed in the inner edge of the neck portion extending from the front section of outer sleeve 2, curved groove 22 formed within outer sleeve 2 relative to curved groove 61 in outer periphery of the front end of notched roller bowl 6, and curved groove 31 formed in disk surface projecting from the front end of inner sleeve 3, as well as curved grooves 61, 62 respectively formed in front end of notched roller bowl 6 at to outer periphery of outer sleeve 2 and rear end of notched roller bowl 6 at inner periphery of spindle 7 have to be formed under a certain matching common difference during the initial manufacturing process, regardless of the corresponding positions or matching common differences, etc., among them. Thereby, it permits smooth rotation of the rollers 4, 5 and the large roller 8 arranged among them, thereby resulting in complications and inconvenience during the initial manufacturing process and assembly process due to difficult matching of their size, corresponding position, common difference, etc.,

2. The rollers 4, 5 are provided to permit a contact rotation between outer sleeve 2 and inner sleeve. The periphery on one side of roller 4 is in contact rotation with curved groove 21 in the inner edge of neck portion extending from the front end of outer sleeve 2, and the periphery on the other side thereof is in contact rotation with curved groove 31 in disk surface projecting from the front end of inner sleeve 3, or the periphery on one side of roller 5 is in contact rotation with curved groove 61 in front end of notched roller bowl 6 at outer periphery of outer sleeve 2, and the periphery on the other side thereof is in contact rotation with curved groove within outer sleeve 2 on the opposite side, all of which form a pressure angle “A” with outer sleeve 2 in the radial directions, thereby resulting in that when the hub is mounted on a bicycle in practice, the radial stress borne by outer sleeve 2 will be affected to a certain extent.

3. Since the rotation between outer sleeve 2 and spindle 7 is achieved by means of outer sleeve 2 that rotates with inner sleeve 3 via rollers 4, 5, and then inner sleeve further rotates with spindle 7 via large roller 8, during the process of rotation between outer sleeve 2 and spindle 7, the distance between outer sleeve 2 and spindle 7 in assembly is merely the distance “B” between rollers 4 and 5, which leads to a reduction in the strength of the structure.

### SUMMARY OF THE INVENTION

Therefore, the primary object of the invention is to provide an improved structure for an hub with a rectangular interior space which includes outer sleeve in combination with inner sleeve, rollers, spindle and bearing. In particular, a section of neck portion extending from a front end of outer sleeve can form a rectangular space with a disk surface projecting from a front end of inner sleeve for arrangement of multiple steel rollers therein. The outer edge of inner sleeve proximate to the tail end is coupled with a connecting seat by threaded engagement or tight fit or gluing or other means such that the inner side of the connecting seat can form another rectangular space with a corresponding position of outer sleeve for arrangement of multiple steel rollers therein. A bearing is disposed between the tail end of outer sleeve and spindle. A right side cover is finally positioned at a rear end of bearing so that outer sleeve and inner sleeve and spindle form three contact fulcrums to thereby increase the distance thereamong during rotation, thereby facilitating manufacture and assembly of the structural elements and enabling smooth and stable rotation and strength of the structure.

### BRIEF DESCRIPTION OF THE DRAWINGS

The foregoing and other features and advantages of the present invention will be more clearly understood from the following detailed description and the accompanying drawings, in which,

FIG. 1 is a schematic sectional view showing a conventional hub with a rectangular interior space in an assembled state;

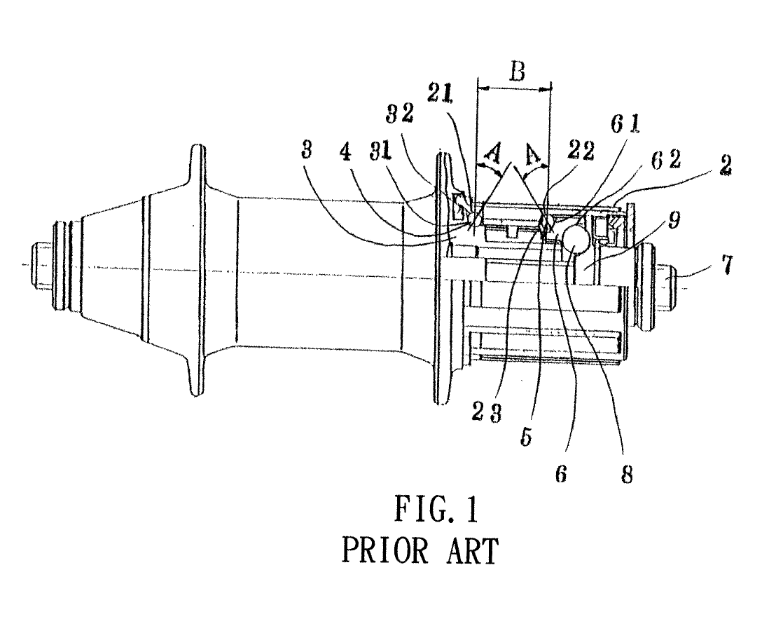

FIG. 2 is a schematic sectional view showing a hub with a rectangular interior space according to the invention;

FIG. 3 is a schematic view showing another embodiment of the hub with a rectangular interior space of the invention; and

FIG. 4 is a schematic view showing a further embodiment of the hub with a rectangular interior space of the invention.

### DETAILED DESCRIPTION OF THE PREFERRED EMBODIMENT

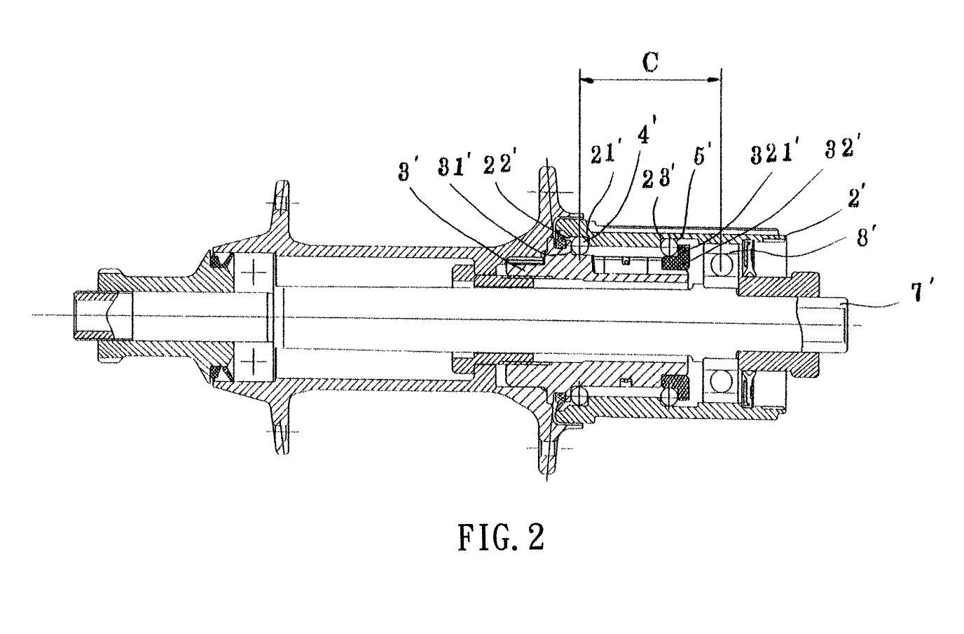

Initially, referring to FIG. 2, the hub with a rectangular interior space for a bicycle according to the invention mainly includes an outer sleeve 2′, an inner sleeve 3′ with the outer sleeve 2′, two rollers 4′, 5′ arranged between the outer sleeve 2′ and the inner sleeve 3′, and a spindle 7′. The feature of the present invention will be described in the following. The inner edge of the section of neck portion extending from the front end of outer sleeve 2′ is especially modified as a right-angle groove 21. The disk surface projecting from the front end of inner sleeve 3′ is also configured as a right-angle groove 31 such that they form a rectangular space 22 for mounting roller 4′ therein so as to performing a contact rotation. The outer end of inner sleeve 3′ near the tail end thereof is coupled to a coupling seat 32′ via threaded engagement or tight fit or gluing or other means. The outer edge of coupling seat 32′ on the side of inner sleeve 3 is provided with right-angle groove 321′. An inner portion of outer sleeve 2′ is also provided with a right-angle groove 23′ to correspond to right-angle groove 321′ such that the two right-angle grooves 321′, 23′ form another rectangular space 24′ for mounting roller 5′ therein for performing a contact rotation. A bearing 8′ is mounted on spindle 7′ at the inner edge of outer sleeve 2′ near tail end, and outer periphery of bearing 8′ can fit on inner periphery of outer sleeve 2′ to provide contact rotation between outer sleeve 2′ and spindle 7′.

After assembly of the above structure, since grooves 21′, 23′ formed in outer sleeve 2′, and groove 31′ formed in disk surface projecting from front end of inner sleeve 3′, and groove 321′ formed in outer edge of coupling seat 32′ on side of inner sleeve 3′ are all formed as right angles, during manufacture of grooves 21′, 23′, 31′, 321′, they can be easily manufactured regardless of their corresponding position or matching common difference, etc., thereby facilitating manufacture and assembly. Further, since right-angle grooves 21′, 23′ of outer sleeve 2′ respectively form rectangular spaces 22′, 24′ with right-angle groove 31′ provided in disk surface projecting from front end of inner sleeve 3′ and right-angle groove 321′ provided in outer edge of coupling seat 32′ on side of inner sleeve 3′, since they permit mounting of rollers 4, 5 therein, when outer sleeve 2′ rotationally contacts inner sleeve 3′, rollers 4, 5 which are disposed inside the rectangular spaces 22′, 24′ and have top and bottom ends directly contacting horizontal inner edge of outer sleeve 2′, horizontal disk surface projecting from front end of inner sleeve 3′, or horizontal surface of right-angle groove 321′ of coupling seat 32′, they would not produce any pressure angle with outer sleeve 2′ in the radial direction. Furthermore, since a bearing 8′ is directly mounted on spindle 7′ at inner edge of outer sleeve 2′ near tail end, and outer periphery of bearing 8′ can be secured on inner periphery of outer sleeve 2′, when outer sleeve 2′ rotationally contacts spindle 7′, outer sleeve 2′ can, via three contact fulcrums at rollers 4′, 5′ and bearing 8′, rotate with inner sleeve 3′ and spindle 7′ smoothly. Besides, since the distance between outer sleeve 2′ and spindle 7′ can be extended to a distance “C” from roller 4′ to bearing 8′, longer than the distance “B” between rollers 4 and 5. Relatively, the strength of the entire structure is enhanced without occurrence of deformation.

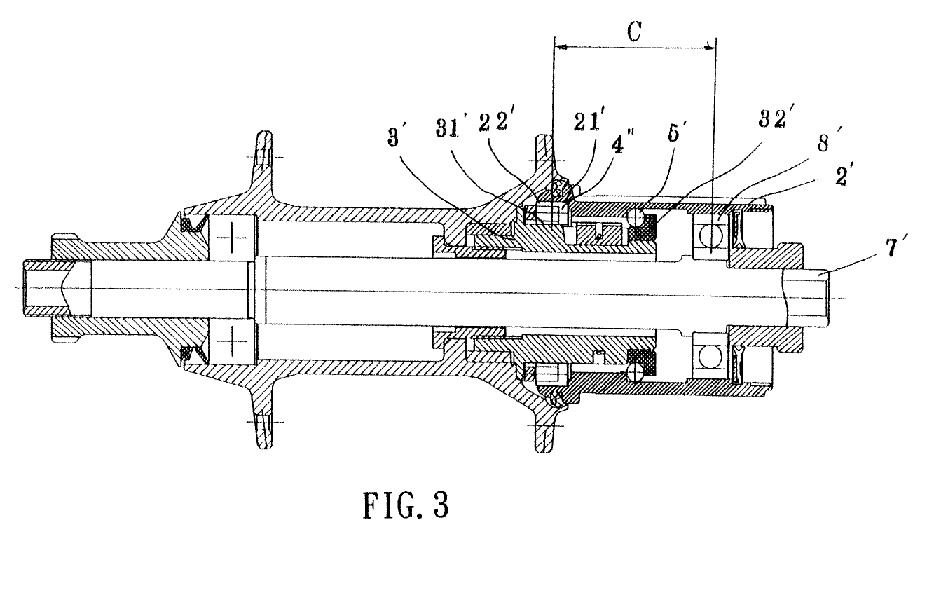

In addition, referring to FIG. 3, the inner edge of the section of neck portion extending from front end of outer sleeve 2′ can be configured to be a right-angled groove 21′, and the disk surface projecting from front end of inner sleeve 3′ can also be provided with a right-angled groove 31′ to thereby form a rectangular space 22′ in which bearing 4″ is disposed to perform contact rotation. Hence, outer sleeve 2′ can likewise rotate with inner sleeve 3′ and spindle 7′ by means of three contact fulcrums at bearing 4″, roller 5′ and bearing 8′. In addition to enabling smooth rotation of the entire structure, the distance between outer sleeve 2′ and spindle 7′ after engagement can be lengthened to reinforce the strength of the entire structure without resulting in deformation.

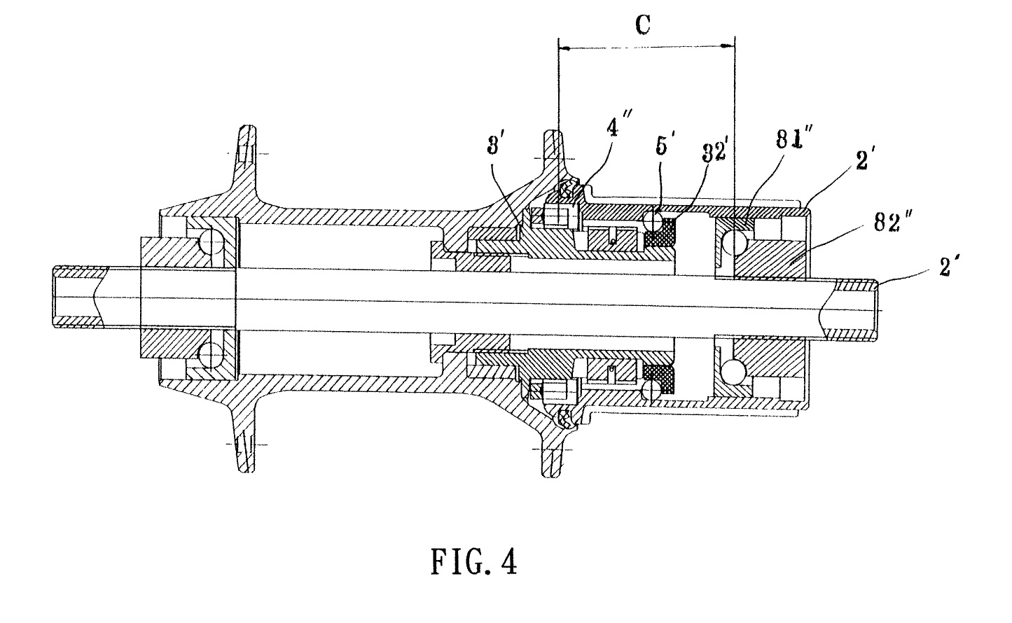

Referring to FIG. 4, the bearing 8′ originally mounted on spindle 7′ near the inner edge of tail end of outer sleeve 2′ are to arrange a roller disk 81″ and a roller rail 82″ so that outer sleeve 2′ can rotate with the inner sleeve 3′ and the spindle 7′ at two contact fulcrums to thereby achieve smooth rotation of the entire structure. In addition, the distance between the outer sleeve 2′ and spindle 7′ after engagement can be lengthened to reinforce the strength of the entire structure without resulting in deformation.

In view of the aforesaid, the drawbacks associated with the prior art can be overcome, and the present invention can achieve effects and advantages over the prior art.

What is claimed is:

1. A hub with a rectangular interior space, the hub comprising an outer sleeve, an inner sleeve located within the outer sleeve, a plurality of rollers arranged between the outer sleeve and the inner sleeve, and a spindle arranged along a central axis of the outer sleeve; wherein
an outer sleeve has a neck portion at a front end thereof; an inner edge of a neck portion is configured as a right-angled groove; and a disk surface projecting from a front end of an inner sleeve is also configured as a right-angled groove so as to form a rectangular space for arrangement of rollers therein to perform a contact rotation;
an outer edge near a tail end of inner sleeve is coupled with a connecting seat; an outer edge of the connecting seat on the inner sleeve side is provided with a right-angled groove and an inner portion of the outer sleeve is provided with a right-angled groove to correspond thereto so as to form another rectangular space for arranging rollers therein to perform a contact rotation;
a bearing is mounted on the spindle at an inner edge near a tail end of outer sleeve such that an outer periphery of the bearing is secured on a periphery of the inner edge of outer sleeve to provide a contact rotation between the outer sleeve and the spindle, whereby three contact fulcrums are formed among the outer sleeve, the inner sleeve and the spindle so as to increase the distance thereamong during rotation; as a result manufacture and assembly of the structural elements are facilitated.

2. The hub with a rectangular interior space as claim in claim 1, wherein the outer edge near a tail end of inner sleeve is coupled with the connecting seat by a way selected from threaded engagement, tight fit, and gluing.

3. The hub with a rectangular interior space as claimed in claim 1, wherein an inner edge of the section of neck portion is configured to be a right-angled groove, and the disk surface projecting from the front end of inner sleeve is provided with a right-angled groove to thereby form a rectangular space; a bearing is disposed in the rectangular space to perform contact rotation, such that outer sleeve can likewise rotate with inner sleeve and spindle by means of three contact fulcrums, thereby enabling smooth rotation of the entire structure, enhancing strength of the assembly without resulting in deformation.

4. The hub with a rectangular interior space as claimed in claim 1, wherein the bearing originally mounted on spindle is modified to an arrangement of roller disk and roller rail so that outer sleeve rotates with the inner sleeve and the spindle at two contact fulcrums.
